(19) United States
(12) Patent Application Publication
(10) Pub. No.: US 2018/0108016 A1
(43) Pub. Date: Apr. 19, 2018

(54) ELECTRONIC PAYMENT RISK PROCESSING

(71) Applicant: Alibaba Group Holding Limited, George Town (KY)

(72) Inventors: Hong Jin, Hangzhou (CN); Binjie Fei, Hangzhou (CN)

(73) Assignee: Alibaba Group Holding Limited, George Town (KY)

(21) Appl. No.: 15/844,042

(22) Filed: Dec. 15, 2017

Related U.S. Application Data
(63) Continuation of application No. PCT/CN2016/085401, filed on Jun. 12, 2016.

(30) Foreign Application Priority Data
Jun. 19, 2015 (CN) 201510347516.8

(51) Int. Cl. G06Q 20/40

(52) U.S. Cl. CPC G06Q 20/4016

(57) ABSTRACT

Past payment thresholds of a payment account are received. A first data sequence is determined by applying a differential operation to the past payment thresholds. A second data sequence is determined by processing the first data sequence. A payment threshold change rule is determined based on the second data sequence. The payment threshold change rule is applied before completing a fund transaction service for the payment account to mitigate the risk of the payment account.

### CROSS REFERENCE TO RELATED APPLICATIONS

This application is a continuation of PCT Application No. PCT/CN2016/085401, filed on Jun. 12, 2016, which claims priority to Chinese Patent Application No. 201510347516.8, filed on Jun. 19, 2015, and each application is incorporated by reference in its entirety.

### BACKGROUND

Currently, individuals, businesses, and organizations keep funds in various accounts, which can be easily accessed for withdrawal, transfers, or deposits. Many types of financial accounts, especially payment accounts are vulnerable to fraudulent withdrawals. In one type of payment account fraud, commonly referred to as a “bust-out” scheme, a perpetrator illegally obtains one or more of payment card or merchant account data with an intent to defraud. The payment account fraud typically involves transferring a portion of the payment account balance or using funds for a purchase transaction of physical items or virtual commodities. Most operations designed to mitigate the risks associated with fraudulent financial activities require frequent human intervention and, sometimes, blocking of accounts for extended periods of time, which is both inconvenient and inefficient.

### SUMMARY

Implementations of the present disclosure include computer-implemented methods for automatically determining a payment threshold. In some implementations, actions include retrieving past payment thresholds of a payment account, determining a first data sequence by applying a differential operation to the past payment thresholds, determining a second data sequence by processing the first data sequence, determining a payment threshold change rule based on the second data sequence, and applying the payment threshold change rule before completing a fund transaction service for the payment account to mitigate the risk of the payment account.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The foregoing and other implementations can each, optionally, include one or more of the following features, alone or in combination. In particular, one implementation can include all the following features:

A first aspect, combinable with any general implementation, includes determining the payment threshold change rule includes performing a regression analysis on the second data sequence to obtain the payment threshold change rule. In a second aspect, combinable with any of the previous or following aspects, performing the regression analysis on the second data sequence to obtain the payment threshold change rule includes: establishing a regression model according to the second data sequence, and determining the payment threshold change rule according to the regression model when a residual error obeys a normal distribution. In a third aspect, combinable with any of the previous or following aspects, determining the first data sequence includes: determining a data quantile according to a preset user interruption rate, and assigning values to the historical transaction data of the user at different moments according to the data quantile to obtain the first data sequence. In a fourth aspect, combinable with any of the previous or following aspects, determining the second data sequence includes: performing a log conversion on the first data sequence to obtain the second data sequence. In a fifth aspect, combinable with any of the previous or following aspects, the service includes at least one of a transfer of data and a payment. A sixth aspect, combinable with any of the previous or following aspects, includes correcting the payment threshold change rule according to a preset condition.

The subject matter described in this specification can be implemented in particular implementations, so as to realize one or more of the following advantages. Automatically obtaining and processing a historical payment threshold to determine a current payment threshold can improve the efficiency of risk mitigation. Setting a validity period for the payment threshold and dynamically adjusting the payment threshold enables adaptation to flexibility of changing a payment strategy. The dynamic change of the payment threshold enables the transaction risk control to be carried out more accurately and securely, and user experience can also be improved.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a system, according to an implementation of the present disclosure.

FIG. 2 is a block diagram illustrating an example of an architecture, according to an implementation of the present disclosure.

FIG. 3 is a flowchart illustrating an example of a method for mitigating risks of payment accounts using an automated payment threshold, according to an implementation of the present disclosure.

FIG. 4 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes risk mitigation by automatically determining payment thresholds for payment accounts, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Online transaction risks can include card theft and account theft. A card thief usually obtains bankcard information (such as, a user name of the card, a card number, a certificate of the card, a mobile phone of the card, a mobile phone check code of the card, a pin number, a zip code, or a security number) of a member or non-member of a bank. The card thief uses the bankcard information to purchase real goods, virtual commodities, and the like or to transfer at least a portion of the balance to an account or a card by means of fast sign-up payment or non-deposit payment. An account thief can illegally obtain a login password and a payment password, and then transfers the balance or performs purchasing transactions.

A payment threshold may be set to mitigate transaction risks. For example, when a payment amount of the current transaction is equal to or exceeds the payment threshold, a user is reminded to determine whether to carry out the transaction, so as to avoid the aforementioned transaction risks to the greatest extent possible. The payment threshold can be determined based on an analysis of historical transaction data of the user. Using frequent manual operations (such as, an operator logging into the back-end server each time the payment threshold is acquired and periodically checking the auditing amount of the risk) to adjust the payment threshold has a relatively low efficiency.

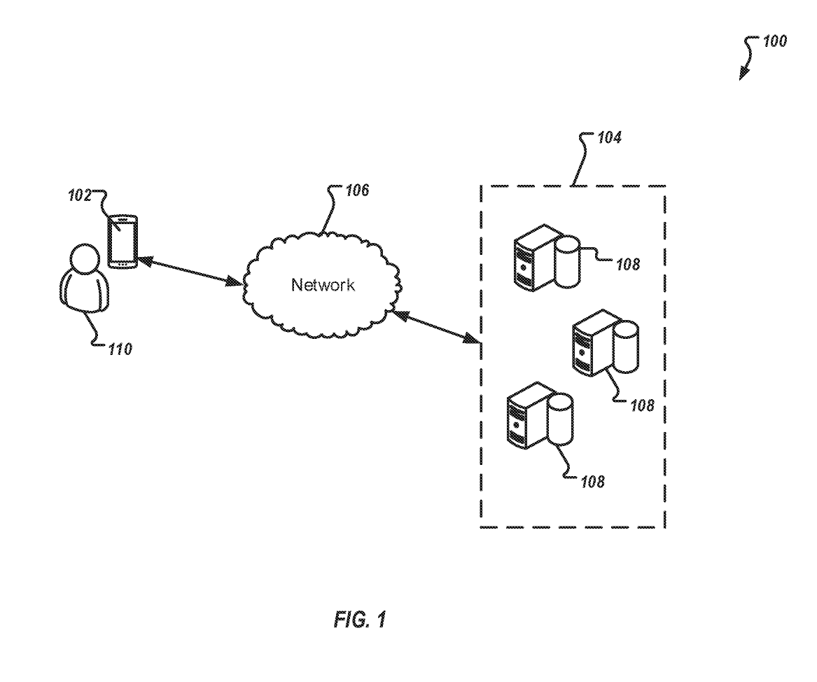

FIG. 1 depicts an example of a system 100 that can be used to execute implementations of the present disclosure. In the depicted example, the example system 100 includes one or more client devices 102, a server system 104 and a network 106. The server system 104 includes one or more server devices 108. In the depicted example, a user 110 interacts with the client device 102. In an example context, the user 110 can include a user, who interacts with a software application (or “application”) that is hosted by the server system 104.

In some examples, the client device 102 can communicate with one or more of the server devices 108 over the network 106. In some implementations, the application processes a transaction request to determine a payment threshold by using user account information stored by the server system 104. The client device 102 can be configured to use one or more payment software provided by the server system 104 and a payment threshold for a transaction amount of the user may be set within the payment software. When a payment amount of the current transaction is equal to or exceeds the payment threshold, the client device 102 can generate an alert that requests a user input to select whether to perform the transaction, so as to avoid transaction risks to the greatest extent possible. The client device 102 can set a payment threshold update period to obtain the payment threshold regularly or to adaptively adjust the payment threshold dynamically in response to detecting a change of a payment strategy.

In some implementations, each server device 108 includes at least one server and at least one data store that stores user account information (such as, a user name of the card, a card number, a certificate of the card, a mobile phone of the card, a mobile phone check code of the card, a pin number, a zip code, a payment address, or a security number). In some implementations, the server system 104 can be provided by a third-party service provider, which stores and provides access to user data including address information, credit score information, fraud information, blacklist information, and others. In the example depicted in FIG. 1, the server devices 108 are intended to represent various forms of servers including, but not limited to, a web server, an application server, a proxy server, a network server, or a server pool. In general, server systems accept requests for application services (such as, pre-loan application services, purchasing orders, or online banking services) and provides such services to any number of client devices (for example, the client device 102) over the network 106.

In accordance with implementations of the present disclosure, the server system 104 can host a risk mitigation algorithm (for example, provided as one or more computer-executable programs executed by one or more computing devices) that applies a payment threshold before completing the transaction or payment request. The server system 104 can send the result data to the client device 102 over the network 106 for display to the user 110.

Implementations of the present disclosure function largely independently of the payment account type, and do not require any modification to the payment method. Implementations of the present disclosure also provide a back-end computing system with payment threshold results associated to a user at a point in time in order to support future risk mitigations.

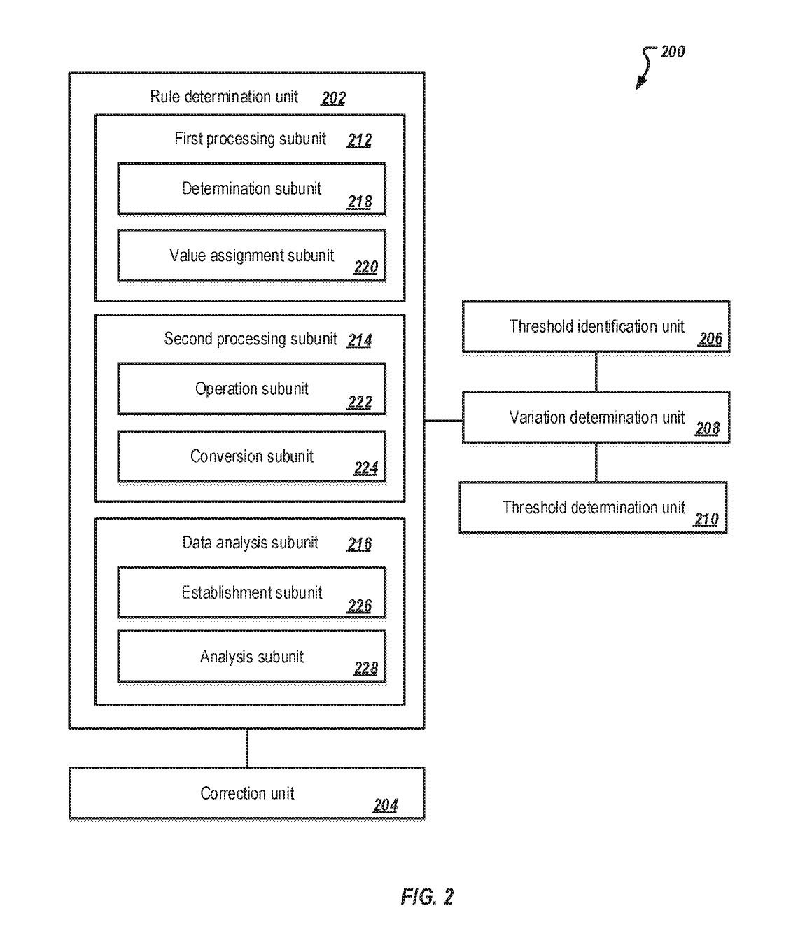

FIG. 2 illustrates an example of an architecture 200 that can be used to execute implementations of the present disclosure. In the depicted example, the example architecture 200 includes a rule determination unit 202, a correction unit 204, a threshold identification unit 206, a variation determination unit 208, and a threshold determination unit 210. The rule determination unit 202 includes a first processing subunit 212, a second processing subunit 214, and a data analysis subunit 216. The first processing subunit 212 is configured to perform first data processing on the historical transaction data of the user at different moments according to a preset rule to obtain a first data sequence. The second processing subunit 214 is configured to perform second data processing on the first data sequence to obtain a second data sequence. The data analysis subunit 216 is configured to perform a regression analysis on the second data sequence to obtain a payment threshold change rule corresponding to historical transaction data of the user at different moments.

The first processing subunit 212 includes a determination subunit 218 and a value assignment subunit 220. The determination subunit 218 is configured to determine a data quantile according to a preset user interruption rate. The determination subunit 218 transmits the data quantile to the value assignment subunit 220. The value assignment subunit 220 is configured to assign values to the historical transaction data of the user at different moments according to a data quantile to obtain the first data sequence. The value assignment subunit 220 transmits the first data sequence to the second processing subunit 222.

The second processing subunit 222 includes an operation subunit 222 and a conversion subunit 224. The operation subunit 222 is configured to perform a difference operation on the first data sequence to obtain a differential sequence. The operation subunit 222 transmits the differential sequence to the conversion subunit 224. The conversion subunit 224 is configured to perform a log conversion on the differential sequence to obtain the second data sequence. The conversion subunit 224 transmits the second data sequence to the data analysis subunit 216.

The data analysis subunit 216 includes an establishment subunit 226 and an analysis subunit 228. The establishment subunit 226 is configured to establish a regression model according to the second data sequence. The establishment subunit 226 transmits the regression model to the analysis subunit 228. The analysis subunit 228 is configured to obtain the payment threshold change rule according to the regression model for residual errors that obey a normal distribution. The analysis subunit 228 transmits the payment threshold change rule to the correction unit 204. The correction unit 204 is configured to correct the payment threshold change rule according to a preset condition. The preset condition can be information or condition regarding payments chosen by the server system (for example, trustworthy payments, untrustworthy payments, or all payments).

The threshold identification unit 206 is configured to obtain a known first payment threshold of a user at a first moment and provide the results to the variation determination unit 208. The variation determination unit 208 is configured to determine a payment threshold variation between a second moment and the first moment according to the payment threshold change rule received from the rule determination unit 202. The variation determination unit 208 transmits the payment threshold variation to the threshold determination unit 210. The threshold determination unit 210 is configured to determine a payment threshold of the user at the second moment according to the first payment threshold and the payment threshold variation.

The example architecture 200 can automatically obtain a historical payment threshold from a database when an instruction is received or a set condition is met. The example architecture 200 can determine a current payment threshold according to a pre-obtained payment threshold change rule, by automatically determining and processing a payment threshold rule that defines a threshold under which payment can be processed and above which payment can be prevented before one or more additional payment conditions are verified as being satisfied. The example architecture 200 can determine the current payment threshold without a user input, thus improving the efficiency of determining the current payment threshold based on historical payment threshold. Moreover, the example architecture 200 can set a validity period for the payment threshold and dynamically adjust the payment threshold to adapt to flexibility of changing a payment strategy. A threshold limit for a risk-control transaction is set by using the current payment threshold, which is dynamically modified based on the historical payment threshold and one or more risk factors (for example, identified risks of payment accounts having one or more similarities to the evaluated payment account). The dynamic update of the payment threshold enables the transaction risk control to be carried out more accurately and securely according to current financial conditions and theft risks, and user experience can also be improved.

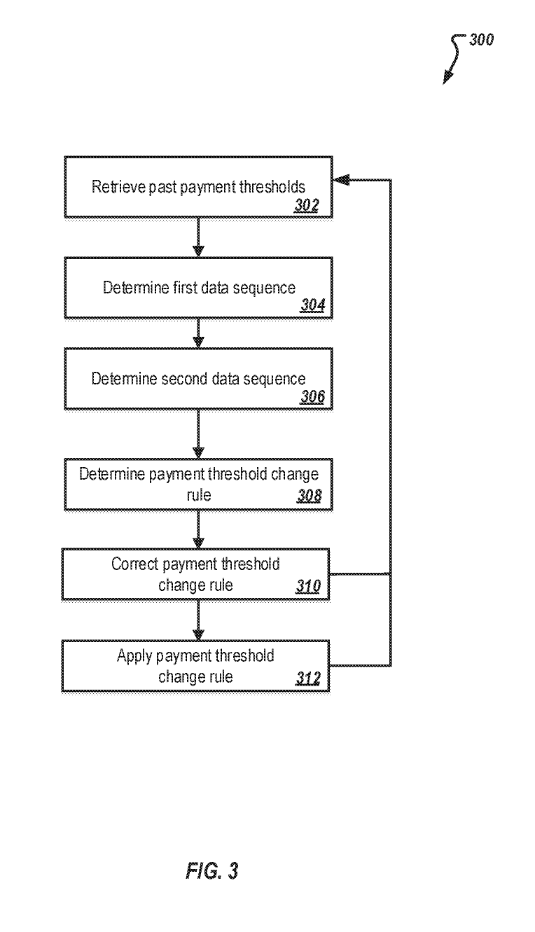

FIG. 3 is a flowchart illustrating an example of a method 300 for mitigating risks of payment accounts using an automated payment threshold, according to an implementation of the present disclosure. Method 300 can be implemented as one or more computer-executable programs executed using one or more computing devices, as described with reference to FIGS. 1, 2, and 4. In some implementations, various steps of the example method 300 can be run in parallel, in combination, in loops, or in any order.

At 302, one or more past payment thresholds (such as, payment thresholds at a first moment and a second moment) are obtained for a user by a back-end server, or an independent module disposed in a server. The past payment thresholds can be obtained in response to receiving an instruction for determining a payment threshold triggered by a user input (such as, a user input requesting a transaction) or by a preset rule. For example, a validity period of the payment threshold or a time interval for updating the payment threshold may be set in advance. The payment threshold within a set period, may be updated at a set time associated to the end of the set period. When the preset rule is met, the past payment thresholds are automatically retrieved to update the payment threshold. The past payment thresholds (such as, the most recent past moment) are values recorded in a database. The payment threshold of any past period of time can be recorded and retrieved for analysis. An initial payment threshold for a payment account can be set by the user of the account or can be obtained according to a particular percentage of a historical transaction amount of the user within a period of time. The percentage may be 1−p, where p is a user interruption rate. From 302, method 300 proceeds to 304.

At 304, the past payment thresholds are processed to determine a first data sequence. The data processing is performed on the historical transaction data of the user at different moments according to a preset rule to obtain a first data sequence. In some implementations, the first data sequence is obtained based on the historical transaction data of the user. The first data sequence may directly affect the result of a payment threshold change rule, while a user interruption rate is one of key indexes for evaluating payment experience. The user interruption rate may be defined as a percentage of the number of interrupted users relative to the total number of users within a set period of time. The first data sequence may be determined with reference to the user interruption rate in this step. The first data processing may include determining a data quantile according to a preset user interruption rate. Supposing that the user interruption rate is preset to p, 1−p may be used as the data quantile. For example, if the user interruption rate is 10%, 1-10% may be used as the data quantile. Values are assigned to the historical transaction data of the user at different moments according to the data quantile to obtain the first data sequence. In this step, 1−p quantiles of the historical transaction data of the user at different moments may be used as the first data sequence.

By using an example in which the historical transaction data is a transaction amount, supposing that the transaction amount of the user on the first day is $100, 100(1−p) is used as data ranked at the first place in the first data sequence. Supposing that a transaction amount of the user on the i^{th} day is ai, ai*(1−p) is used as data ranked at the i^{th} place in the first data sequence. The rest can be obtained by analogy, and thus the first data sequence can be obtained. Supposing that the first data sequence is {xᵢ}, where xᵢ is the 1−p quantile of the transaction amount on the i^{th} day, where i=1, . . . n. In some implementations, the transaction data can include the transaction amount or the number of transactions. The user data can include a user account, a user bankcard, or a user device. From 304, method 300 proceeds to 306.

At 306, the first data sequence is processed to determine a second data sequence. The first data sequence is processed to determine a payment threshold variation. For example, a differential operation is performed on the first data sequence to obtain a differential sequence. A first-order differential operation may be performed on the first data sequence to obtain a differential sequence. Supposing that a variable f depends on an independent variable t, when t becomes t+1, the variation of a dependent variable f=f(t) is D_{f(t)}=f(t+1)−f(t), where D_{f(t)} is referred to as a first-order differential of the function ƒ(t) at the point t. The first-order differential operation is performed on the first data sequence to obtain a differential sequence {yⱼ}, j=1, . . . , n−1. A log conversion is performed on the differential sequence to obtain a second data sequence. The log conversion is performed on the differential sequence to obtain a second data sequence {zⱼ}. The first-order difference operation and the log conversion are similar to existing methods, and details are not described herein again. From 306, method 300 proceeds to 308.

At 308, the second data sequence is processed to obtain the payment threshold change rule. In some implementations, the payment threshold change rule can be obtained by assigning data value, data processing, model analysis, and other processes according to historical transaction data of the user at different moments. The payment threshold change rule can define a relation between the payment threshold and transaction data of the user at a particular moment and a time interval between the particular moment and the current moment. For example, the payment threshold xⱼ at a particular moment i can be defined based on the second data sequence is zⱼ as:

xᵢ₊₁=xⱼ+Σᵢ^{j}e^{zj+λ}^{ᵢ}, (1).

The moment i is defined as a natural number and λ is a random number. A regression model is established according to the second data sequence. The payment threshold change rule is obtained according to the regression model for a residual error that obeys a normal distribution.

In a specific example, suppose that a past data sequence obtained according to historical transaction amounts of the user at different moments is as follows:

{x₁ . . . , x₁₅}={3000, 5000, 6000, 6500, 6800, 7000, 7180, 7330, 7450, 7550, 7630, 7700, 7750, 7780, 7800}.

First-order differences of the first data sequence are taken to obtain a first data sequence as a differential sequence, which is as follows:

{y₁, . . . , y₁₄}={2000, 1000, 500, 300, 200, 180, 150, 120, 100, 80, 70, 50, 30, 20}.

Then, log processing is performed on the differential sequence to obtain a second data sequence, which is as follows:

{zⱼ}=log(yⱼ)={7.60, 6.91, 6.21, 5.70, 5.30, 5.19, 5.01, 4.79, 4.61, 4.38, 4.25, 3.91, 3.40, 3.00}, j=1, . . . 14

A regression model is established for the second data sequence. If a residual error obeys a normal distribution, it is finally obtained that: zⱼ=7.25905−0.29872j. According to the result of the regression model, a Prob value can be equal to 4.261e-09<0.05 and the residual error εᵢ obeys the normal distribution N(−0.02786, 0.9486). The payment threshold change rule may be obtained according to Equation (1):

xᵢ₊₁=Σⱼ₌₁ⁱe^{7.25905-0.298721j},i=1, . . . ,n.

xᵢ₊₁ is a payment threshold on the (i+1)^{th} day. x₁ is the 1−p quantile of the transaction amount on the first day, and x₁ can be used as an initial payment threshold of the user. To make the payment threshold difficult to exceed, the random number λᵢ is added on the basis of the original payment threshold to finally obtain the payment threshold change rule:

xᵢ₊₁=x₁+Σⱼ₌₁ⁱe^{7.25905-0.29872j+λ}^{ᵢ},i=1, . . . ,n−1.

The process of determining the residual error from the regression model and determining the data sequence according to the distribution of the residual error is similar to the existing regression analysis process, and details are not described herein again. From 308, method 300 proceeds to 310.

At 310, the method the payment threshold change rule is selectively corrected based on a preset condition. Specifically, after the payment threshold is performed by using the payment threshold change rule, auditing may be carried out regularly (for example, every week) or when a preset condition is met, to obtain scenario-auditing data. For example, m users are audited, M users meet an auditing condition (where the condition may be set as required), and the number of uninterrupted users is M*(1−p), where p is the user interruption rate. In this case, a correction amount may be obtained:

$$ratio = \frac{m - M ( 1 - P )}{M ( 1 - P )} .$$

After the correction amount is obtained, the first data sequence may be adjusted according to the correction amount. For example, it is set that xᵢ′=xᵢ*(1+ratio). The foregoing steps 302 to 308 are repeated according to the adjusted first data sequence to obtain a corrected payment threshold change rule. From 310, method 300 proceeds to 312.

At 312, the payment threshold change rule is applied to prevent a fraudulent payment from the payment account. The payment threshold change rule is dynamically applied, so that transaction risk control can be carried out more accurately and securely, and user experience is also improved. In some implementations, different payment threshold change rules are applied to transaction data of different users that can be significantly different and not associated with each other. In all transaction scenarios and service scenarios, transaction unit prices may be different. For example, prices for phone bills, Q coins, and game currency are relatively low, and for transfer to cards, the transfer amount is generally over $10. In some implementations, the historical transaction data of a user can further be processed based on different scenarios to obtain payment threshold change rules that apply to different scenarios. After 312, method 300 stops.

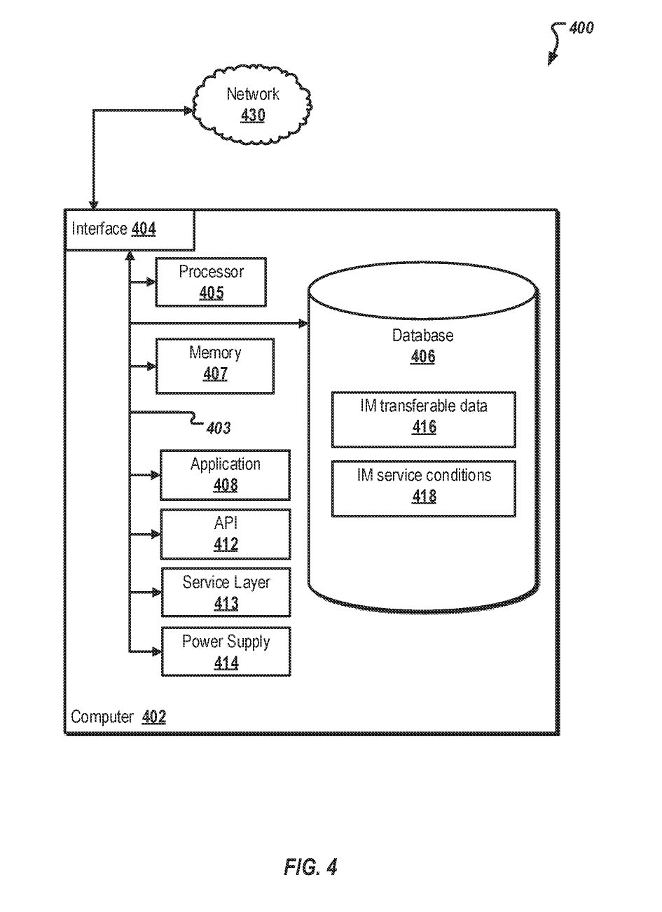

FIG. 4 is a block diagram illustrating an example of a computer-implemented System 400 used to provide computational functionalities associated with described algorithms, methods, functions, processes, flows, and procedures, according to an implementation of the present disclosure. In the illustrated implementation, System 400 includes a Computer 402 and a Network 430.

The illustrated Computer 402 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the Computer 402 can include an input device, such as a keypad, keyboard, touch screen, another input device, or a combination of input devices that can accept user information, and an output device that conveys information associated with the operation of the Computer 402, including digital data, visual, audio, another type of information, or a combination of types of information, on a graphical-type user interface (UI) (or GUI) or other UI.

The Computer 402 can serve in a role in a distributed computing system as a client, network component, a server, a database or another persistency, another role, or a combination of roles for performing the subject matter described in the present disclosure. The illustrated Computer 402 is communicably coupled with a Network 430. In some implementations, one or more components of the Computer 402 can be configured to operate within an environment, including cloud-computing-based, local, global, another environment, or a combination of environments.

At a high level, the Computer 402 is an electronic computing device operable to receive, transmit, process, store, or manage data and information associated with the described subject matter. According to some implementations, the Computer 402 can also include or be communicably coupled with a server, including an application server, e-mail server, web server, caching server, streaming data server, another server, or a combination of servers.

The Computer 402 can receive requests over Network 430 (for example, from a client software application executing on another Computer 402) and respond to the received requests by processing the received requests using a software application or a combination of software applications. In addition, requests can also be sent to the Computer 402 from internal users (for example, from a command console or by another internal access method), external or third-parties, or other entities, individuals, systems, or computers.

Each of the components of the Computer 402 can communicate using a System Bus 403. In some implementations, any or all of the components of the Computer 402, including hardware, software, or a combination of hardware and software, can interface over the System Bus 403 using an application programming interface (API) 412, a Service Layer 413, or a combination of the API 412 and Service Layer 413. The API 412 can include specifications for routines, data structures, and object classes. The API 412 can be either computer-language independent or dependent and refer to a complete interface, a single function, or even a set of APIs. The Service Layer 413 provides software services to the Computer 402 or other components (whether illustrated or not) that are communicably coupled to the Computer 402. The functionality of the Computer 402 can be accessible for all service consumers using the Service Layer 413. Software services, such as those provided by the Service Layer 413, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the Computer 402, alternative implementations can illustrate the API 412 or the Service Layer 413 as stand-alone components in relation to other components of the Computer 402 or other components (whether illustrated or not) that are communicably coupled to the Computer 402. Moreover, any or all parts of the API 412 or the Service Layer 413 can be implemented as a child or a sub-module of another software module, enterprise application, or hardware module without departing from the scope of the present disclosure.

The Computer 402 includes an Interface 404. Although illustrated as a single Interface 404, two or more Interfaces 404 can be used according to particular needs, desires, or particular implementations of the Computer 402. The Interface 404 is used by the Computer 402 for communicating with another computing system (whether illustrated or not) that is communicatively linked to the Network 430 in a distributed environment. Generally, the Interface 404 is operable to communicate with the Network 430 and includes logic encoded in software, hardware, or a combination of software and hardware. More specifically, the Interface 404 can include software supporting one or more communication protocols associated with communications such that the Network 430 or hardware of Interface 404 is operable to communicate physical signals within and outside of the illustrated Computer 402.

The Computer 402 includes a Processor 405. Although illustrated as a single Processor 405, two or more Processors 405 can be used according to particular needs, desires, or particular implementations of the Computer 402. Generally, the Processor 405 executes instructions and manipulates data to perform the operations of the Computer 402 and any algorithms, methods, functions, processes, flows, and procedures as described in the present disclosure.

The Computer 402 also includes a Database 406 that can hold data for the Computer 402, another component communicatively linked to the Network 430 (whether illustrated or not), or a combination of the Computer 402 and another component. For example, Database 406 can be an in-memory, conventional, or another type of database storing data consistent with the present disclosure. In some implementations, Database 406 can be a combination of two or more different database types (for example, a hybrid in-memory and conventional database) according to particular needs, desires, or particular implementations of the Computer 402 and the described functionality. Although illustrated as a single Database 406, two or more databases of similar or differing types can be used according to particular needs, desires, or particular implementations of the Computer 402 and the described functionality. While Database 406 is illustrated as an integral component of the Computer 402, in alternative implementations, Database 406 can be external to the Computer 402. As illustrated, the database 406 holds previously described IM transferable data 416 (for example, virtual currency, bonus points) and IM service conditions 418.

The Computer 402 also includes a Memory 407 that can hold data for the Computer 402, another component or components communicatively linked to the Network 430 (whether illustrated or not), or a combination of the Computer 402 and another component. Memory 407 can store any data consistent with the present disclosure. In some implementations, Memory 407 can be a combination of two or more different types of memory (for example, a combination of semiconductor and magnetic storage) according to particular needs, desires, or particular implementations of the Computer 402 and the described functionality. Although illustrated as a single Memory 407, two or more Memories 407 or similar or differing types can be used according to particular needs, desires, or particular implementations of the Computer 402 and the described functionality. While Memory 407 is illustrated as an integral component of the Computer 402, in alternative implementations, Memory 407 can be external to the Computer 402.

The Application 408 is an algorithmic software engine providing functionality according to particular needs, desires, or particular implementations of the Computer 402, particularly with respect to functionality described in the present disclosure. For example, Application 408 can serve as one or more components, modules, or applications. Further, although illustrated as a single Application 408, the Application 408 can be implemented as multiple Applications 408 on the Computer 402. In addition, although illustrated as integral to the Computer 402, in alternative implementations, the Application 408 can be external to the Computer 402.

The Computer 402 can also include a Power Supply 414. The Power Supply 414 can include a rechargeable or non-rechargeable battery that can be configured to be either user- or non-user-replaceable. In some implementations, the Power Supply 414 can include power-conversion or management circuits (including recharging, standby, or another power management functionality). In some implementations, the Power Supply 414 can include a power plug to allow the Computer 402 to be plugged into a wall socket or another power source to, for example, power the Computer 402 or recharge a rechargeable battery.

There can be any number of Computers 402 associated with, or external to, a computer system containing Computer 402, each Computer 402 communicating over Network 430. Further, the term “client,” “user,” or other appropriate terminology can be used interchangeably, as appropriate, without departing from the scope of the present disclosure. Moreover, the present disclosure contemplates that many users can use one Computer 402, or that one user can use multiple computers 402.

Described implementations of the subject matter can include one or more features, alone or in combination.

For example, in a first implementation, a computer-implemented method for mitigating a risk of a payment account that is executed by one or more processors includes: retrieving, by the one or more processors, past payment thresholds of the payment account, determining, by the one or more processors, a first data sequence by applying a differential operation to the past payment thresholds, determining, by the one or more processors, a second data sequence by processing the first data sequence, determining, by the one or more processors, a payment threshold change rule based on the second data sequence, and applying, by the one or more processors, the payment threshold change rule before completing a fund transaction service for the payment account to mitigate the risk of the payment account.

The foregoing and other described implementations can each, optionally, include one or more of the following features:

In a first feature, combinable with any of the following features, determining the payment threshold change rule includes performing a regression analysis on the second data sequence to obtain the payment threshold change rule.

In a second feature, combinable with any of the previous or following features, performing the regression analysis on the second data sequence to obtain the payment threshold change rule includes: establishing a regression model according to the second data sequence, and determining the payment threshold change rule according to the regression model when a residual error obeys a normal distribution.

In a third feature, combinable with any of the previous or following features, determining the first data sequence includes: determining a data quantile according to a preset user interruption rate, and assigning values to the historical transaction data of the user at different moments according to the data quantile to obtain the first data sequence.

In a fourth feature, combinable with any of the previous or following features, determining the second data sequence includes: performing a log conversion on the first data sequence to obtain the second data sequence.

In a fifth feature, combinable with any of the previous or following features, the service includes at least one of a transfer of data and a payment.

A sixth feature, combinable with any of the previous or following features, includes correcting the payment threshold change rule according to a preset condition.

In a second implementation, a non-transitory, computer-readable medium storing one or more instructions executable by a computer system to perform operations includes: retrieving past payment thresholds of a payment account, determining a first data sequence by applying a differential operation to the past payment thresholds, determining a second data sequence by processing the first data sequence, determining a payment threshold change rule based on the second data sequence, and applying the payment threshold change rule before completing a fund transaction service for the payment account to mitigate the risk of the payment account.

The foregoing and other described implementations can each, optionally, include one or more of the following features:

In a first feature, combinable with any of the following features, determining the payment threshold change rule includes performing a regression analysis on the second data sequence to obtain the payment threshold change rule.

In a second feature, combinable with any of the previous or following features, performing the regression analysis on the second data sequence to obtain the payment threshold change rule includes: establishing a regression model according to the second data sequence, and determining the payment threshold change rule according to the regression model when a residual error obeys a normal distribution.

In a third feature, combinable with any of the previous or following features, determining the first data sequence includes: determining a data quantile according to a preset user interruption rate, and assigning values to the historical transaction data of the user at different moments according to the data quantile to obtain the first data sequence.

In a fourth feature, combinable with any of the previous or following features, determining the second data sequence includes: performing a log conversion on the first data sequence to obtain the second data sequence.

In a fifth feature, combinable with any of the previous or following features, the service includes at least one of a transfer of data and a payment.

A sixth feature, combinable with any of the previous or following features, includes correcting the payment threshold change rule according to a preset condition.

In a third implementation, a computer-implemented system for secure offline payment, includes one or more computers, and one or more computer memory devices interoperably coupled with the one or more computers and having tangible, non-transitory, machine-readable media storing instructions that, when executed by the one or more computers, perform operations including: retrieving past payment thresholds of a payment account, determining a first data sequence by applying a differential operation to the past payment thresholds, determining a second data sequence by processing the first data sequence, determining a payment threshold change rule based on the second data sequence, and applying the payment threshold change rule before completing a fund transaction service for the payment account to mitigate the risk of the payment account.

The foregoing and other described implementations can each, optionally, include one or more of the following features:

In a first feature, combinable with any of the following features, determining the payment threshold change rule includes performing a regression analysis on the second data sequence to obtain the payment threshold change rule.

In a second feature, combinable with any of the previous or following features, performing the regression analysis on the second data sequence to obtain the payment threshold change rule includes: establishing a regression model according to the second data sequence, and determining the payment threshold change rule according to the regression model when a residual error obeys a normal distribution.

In a third feature, combinable with any of the previous or following features, determining the first data sequence includes: determining a data quantile according to a preset user interruption rate, and assigning values to the historical transaction data of the user at different moments according to the data quantile to obtain the first data sequence.

In a fourth feature, combinable with any of the previous or following features, determining the second data sequence includes: performing a log conversion on the first data sequence to obtain the second data sequence.

In a fifth feature, combinable with any of the previous or following features, the service includes at least one of a transfer of data and a payment.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatus, devices, and machines for processing data, including by way of example, a programmable processor, a computer, or multiple processors or computers. The computer can also be, or further include special purpose logic circuitry, for example, a central processing unit (CPU), an FPGA (field programmable gate array), or an ASIC (application-specific integrated circuit). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client-computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for mitigating a risk of a payment account, the method being executed by one or more processors and comprising:
retrieving, by the one or more processors, past payment thresholds of the payment account;
determining, by the one or more processors, a first data sequence by applying a differential operation to the past payment thresholds;
determining, by the one or more processors, a second data sequence by processing the first data sequence;
determining, by the one or more processors, a payment threshold change rule based on the second data sequence; and
applying, by the one or more processors, the payment threshold change rule before completing a fund transaction service for the payment account to mitigate the risk of the payment account.

2. The computer-implemented method of claim 1, wherein determining the payment threshold change rule comprises performing a regression analysis on the second data sequence to obtain the payment threshold change rule.

3. The computer-implemented method of claim 2, wherein performing the regression analysis on the second data sequence to obtain the payment threshold change rule comprises:
establishing a regression model according to the second data sequence; and
determining the payment threshold change rule according to the regression model when a residual error obeys a normal distribution.

4. The computer-implemented method of claim 1, wherein determining the first data sequence comprises:
determining a data quantile according to a preset user interruption rate; and
assigning values to the historical transaction data of the user at different moments according to the data quantile to obtain the first data sequence.

5. The computer-implemented method of claim 1, wherein determining the second data sequence comprises: performing a log conversion on the first data sequence to obtain the second data sequence.

6. The computer-implemented method of claim 1, wherein the service comprises at least one of a transfer of data and a payment.

7. The computer-implemented method of claim 1, further comprising correcting the payment threshold change rule according to a preset condition.

8. A non-transitory, computer-readable medium storing one or more instructions executable by a computer system to perform operations comprising:
retrieving past payment thresholds of a payment account;
determining a first data sequence by applying a differential operation to the past payment thresholds;
determining a second data sequence by processing the first data sequence;
determining a payment threshold change rule based on the second data sequence; and
applying the payment threshold change rule before completing a fund transaction service for the payment account to mitigate the risk of the payment account.

9. The non-transitory, computer-readable medium of claim 8, wherein determining the payment threshold change rule comprises performing a regression analysis on the second data sequence to obtain the payment threshold change rule.

10. The non-transitory of claim 9, wherein performing the regression analysis on the second data sequence to obtain the payment threshold change rule comprises:
establishing a regression model according to the second data sequence; and
determining the payment threshold change rule according to the regression model when a residual error obeys a normal distribution.

11. The non-transitory, computer-readable medium of claim 8, wherein determining the first data sequence comprises:
determining a data quantile according to a preset user interruption rate; and
assigning values to the historical transaction data of the user at different moments according to the data quantile to obtain the first data sequence.

12. The non-transitory, computer-readable medium of claim 8, wherein determining the second data sequence comprises: performing a log conversion on the first data sequence to obtain the second data sequence.

13. The non-transitory, computer-readable medium of claim 8, wherein the service comprises at least one of a transfer of data and a payment.

14. The non-transitory, computer-readable medium of claim 8, further comprising correcting the payment threshold change rule according to a preset condition.

15. A computer-implemented system for secure offline payment, comprising:
one or more computers; and
one or more computer memory devices interoperably coupled with the one or more computers and having tangible, non-transitory, machine-readable media storing instructions that, when executed by the one or more computers, perform operations comprising:
retrieving past payment thresholds of a payment account;
determining a first data sequence by applying a differential operation to the past payment thresholds;
determining a second data sequence by processing the first data sequence;
determining a payment threshold change rule based on the second data sequence; and
applying the payment threshold change rule before completing a fund transaction service for the payment account to mitigate the risk of the payment account.

16. The computer-implemented system of claim 15, wherein determining the payment threshold change rule comprises performing a regression analysis on the second data sequence to obtain the payment threshold change rule.

17. The computer-implemented system of claim 16, wherein performing the regression analysis on the second data sequence to obtain the payment threshold change rule comprises:
establishing a regression model according to the second data sequence; and
determining the payment threshold change rule according to the regression model when a residual error obeys a normal distribution.

18. The computer-implemented system of claim 15, wherein determining the first data sequence comprises:
determining a data quantile according to a preset user interruption rate; and
assigning values to the historical transaction data of the user at different moments according to the data quantile to obtain the first data sequence.

19. The computer-implemented system of claim 15, wherein determining the second data sequence comprises: performing a log conversion on the first data sequence to obtain the second data sequence.

20. The computer-implemented system of claim 15, wherein the service comprises at least one of a transfer of data and a payment.
